(19) United States
(12) Patent Application Publication
(10) Pub. No.: US 2002/0038616 A1
(43) Pub. Date: Apr. 4, 2002

(54) Concrete containing superplasitciser and palygorskite

(76) Inventor: Anders Henrichsen, Hellerup (DK)

Correspondence Address: DARBY & DARBY P.C., 805 Third Avenue, New York, NY, 10022, US

(21) Appl. No.: 09/881,575

(22) Filed: Jun. 14, 2001

Related U.S. Application Data
(63) Continuation of application No. PCT/DK99/00697, filed on Dec. 13, 1999.

(30) Foreign Application Priority Data
Dec. 14, 1998 (DK) PA 1998 01640

(51) Int. Cl. C04B 7/00; C04B 7/34; C04B 28/04; C04B 28/00; C04B 32/00; C04B 9/12; C04B 2/10

(52) U.S. Cl. 106/713; 106/638; 106/739

(57) ABSTRACT

Concept for a self-compacting, self-levelling High Performance Concrete by addition of 2-10% palygorskite with an aspect ratio (length:diameter) of more than 35. The addition of palygorskite in combination with a superplasticiser lends itself to control of the ratio between viscosity and yield strength of the fresh concrete. Good visco-elastic properties, which assure high filling capacity, good flow properties and stability of the microstructure are obtained through this concept. Concrete produced in accordance with this invention is particularly characterised by its self-compacting properties, its filling capacity and its high stability during pumping even at high pumping pressures of 100 to 200 bars.

### SCOPE OF INVENTION

Production of concrete, including concrete structures characterized by High Performance, e.g. enhanced service lifetime, high strength, high resistance towards environmental exposure.

### BACKGROUND

In modern High Strength/High Performance Concretes a number of deficiencies have been recorded. The main defects may be characterized as follows:

Bonding defects at coarse aggregate and reinforcement mainly evolved as highly porous zones of varying thickness.

Uneven homogeneity of the cement paste. i.e. varied porosity.

Cracks. both macroscopic, e.g. from exposed surfaces and microscopic, e.g. bundles of plastic cracks internally in the concrete volume.

Uneven distribution of coarse aggregate

Poor quality of the air void structure mainly characterized by low specific surface and high spacing factor.

Lack of hydration of cement locally in the cement paste.

These defects are caused by a variety of conditions in both the fresh and the hardening concrete.

It is the theory of the applicants that a majority of the deficiencies may be related to instability of modern concretes on micro- as well as macro level in combination with the commonly applied vibration technique.

This is the reason why the concrete material and the concept which are the subject of the present patent claims were developed with the objective of obtaining a high degree of stability to avoid such degradation in combination with rheological properties which will lead to a self-leveling and self-compacting behaviour. The innovative concrete composition shall be characterised by a high viscosity and low yield strength. This is achieved a.o. by addition of 2-10% palygorskite in combination with addition of superplasticising chemical additives.

A number of other patents describe the use of palygorskite in concrete but the application differs from the use in our invention on the following points:

The Japanese patent JP 7277795 by Denki Kagaku Kogoy KK describes the addition of 0.25-5% (of the cement wt.) of water-reducing additives in combination with 0.1-15% of an inorganic material such as bentonite, phlogopite, zeolite, carbon, coke or attapulgite in order to eliminate viscosity, reduce slump and enhance strength in concrete. This deviates from our invention by referring to a broad group of inorganic materials including attapulgite (palygorskite) whereas in our invention, only the particle shape of the palygorskite is considered of importance and whereas we prescribe the use of a superplasticising additive as a prerogative for the predicted behaviour. Further, the invention claims that the use of inorganic materials alms at eliminating viscosity, whereas our invention has the objective of increasing the viscosity without increase in the yield strength.

The Japanese patent JP 7053248 from Denki Kagaku Kogoy KK describes an addition of 0.25-0.5% of water-reducing additives in combination with 0.1-15% of an inorganic material from a group consisting of bentonite, phlogopite, graphite, talc, zeolite, boron nitride, activated carbon, coal cinders, diatomaceous earth, perlite and attapulgite with the aim of reducing viscosity and prevent drying-out shrinkage in the plastic concrete, whereas in our invention only the particle shape of attapulgite in combination with superplasticiser is claimed to result in the desired properties. The present invention does, further, aim at increasing and not reducing the viscosity.

The Japanese patent JP 6144909 from Ohbayashi Corp. refer to application of fibrous clay minerals such as sepiolite, attapulgite and palygorskite in combination with a cellulosic segregation reducing agent such as methyl cellulose with the aim of improving the stability of concrete. This patent deviates from our invention by using palygorskite together with and as part substitution for cellulose fibres and by using these materials without a superplasticiser. Further, the purpose is production of aerial concretes.

The Japanese patent JP 5238800 from Ohbayashi Corp. applies palygorskite or sepiolite in a cement mortar to improve the strength, whereas the use of palygorskite in our invention serves a Theological purpose. Further, the use of superplasticiser is not prescribed in the Japanese patent.

The Japanese patent JP 64003040 from Denki Kogoy KK describes the addition of inorganic matter selected from bentonite, phlogopite, brimstone, zeolite. activated carbon, coal cinders and attapulgite with a high-performance water-reducing agent such as polyalkylsulfonate. The aim of this patent is to improve the handling properties of concrete and to improve strength. This deviates from our invention by reference to a broad group of inorganic materials incl. palygorskite, whereas our invention only mentions palygorskite and prescribes the use of these materials in combination with a superplasticiser which is necessary to achieve the desired effect.

The Japanese patent JP 920293048 from Ohbayashi Corp. refers to use of fibrous clay minerals together with cellulose polymers in order to improve the stability of concrete. This deviates from our invention by the use of palygorskite together with cellulose fibres (polymers) and by not prescribing the use of superplasticisers. Further, the patent does not claim the objective of producing self-levelling vibration-free concrete.

The Japanese patent JP 900058967 from Tokyo Kensetsu KK describes the use of sepiolite and palygorskite in order to improve the segregation resistance of a roller compacted concrete. Our invention does not address the RCC concept and the Japanese invention does not mention the use of palygorskite in combination with superplasticiser, which is not a common ingredient in RCC.

The Japanese patent JP 840094587 from Nisso Master Builders KK prescribe the: use of sepiolite or attapulgite in combination with conventional plasticisers to obtain improved workability. This deviates from our invention by use of palygorskite to improve workability of ordinary plasticised concretes and not with the objective of controlling superplasticised, self-levelling concretes.

The Japanese patent 60255654 from Nisso Master Builders KK prescribes the use of crushed sepiolite mineral in combination with a fluidising agent in the fluidisation of concrete. ‘Pref. Sepiolite mineral is aggregate of magnesium silicate needle crystals such as attapulgite or sepiolite, etc.’

Basically, sepiolite and palygorskite (often called attapulgite) both belong to the layer silicates of inverted ribbons, group sepiolite-palygorskite, but sepiolite belongs to the trioctahedral subgroup and palygorskite to the dioctahedral subgroup. (1). Sepiolite has the ideal formula Mg₈Si₁₂(OH₂)₄(H₂O)₄, while palygorskite has the ideal formula Al₄Si₈(OH₂)₄(OH)₂(H₂O)₄(2) and has, thus, 4AI octahedral cations while sepiolite has 8 Mg octahedral cations. In fact, dioctahedral laver silicates contain typically Al and trioctahedral M, because of the larger size of the Mg cation compared to Al. The two minerals are, thus, clearly different, and sepiolite is the Mg-containing one. Palygorskite is predominantly needle-shaped and sepiolite most often ribbon shaped. Since palygorskite is not a (trioctaliedral) magnesium silicate but instead a (dioctahedral) aluminum silicate, the patent 60255654 does not refer to the mineral palygorskite and is, thus, not in conflict with the present patent application.

Whereas we do recognise that self-levelling or self-compacting concretes at present may be considered known technology, we do also maintain that these concretes are never produced by use of the combination palygorskite/superplasticiser and, further, that the concept of self-levelling or self-compacting concrete was first mentioned in the literature in Japan 1986 (3). Consequently, none of the mentioned patents can address this topic, which was unknown at the time of the patent.

State-of-the-art concretes in this field apply elongated polymers as e.g. polysaccharides instead of palygorskite. One commonly used product is ‘Velan gum’ from the company Monsanto Ltd.

The cost of this product is a magnitude higher than the predicted market price of palygorskite. Further, of an inorganic product like palygorskite can be added during production of a cement having rheology controlling properties.

This technique is unknown today, though it offers large advantages. Both above mentioned records underline the innovative aspects of the present invention.

We have not found any patents which claim the use of a combination of palygorskite and superplasticiser to produce self-levelling and self-compacting concretes by means of controlling (maximising) the viscosity/yield strength ratio. The decisive part of our invention is exactly these properties and the related property ‘filling capacity’. This invention will cause that the previously used method of vibration to consolidate the concrete may be redundant and the deficiencies as described under ‘background’ may be prevented.

The invention is, thus, innovative and not in conflict with any known patent even though the use of palygorskite as illustrated above is not unknown.

References

(1) Bailey, S. W. (1984) Structures of layer silicates (pages 5 and 104-115). In Crystal Structures of Clay Minerals and their X-ray Identification (edited by G. W. Briendley and G. Brown). Mineralogical Society, London.

(2) Drits, V. A. and Sokolova, G. V. (1971) Structure of palygorskite. Soviet Phys. Crystallogr. vol. 16, p. 183-185.

(3) Skarendahl, A (1999) CBI Nytt, no 2, July 1999

Specification

The invention deals with production of self-levelling, self-compacting concrete, characterised by a high filling capacity and good stability of the cementitious microstructure achieved by adding 2-10% palygorskite measured as % by weight of the total dry binder. Particularly, the concrete is characterised by a high micro stability when exposed to high pumping pressures (100-200 bar), high segregation resistance and a high ratio between viscosity and yield strength of the fresh concrete.

The concrete is, further, characterised by the following properties.

flow properties are obtained by composition of the aggregates for easy flow and by use of superplasticisers to such an extent that the concrete without palygorskite addition would reach a slump exceeding 150 mm.

flow properties in relation to confined casting space because of dimensional reductions, reinforcement etc. are significantly improved by addition of palygorskite, which decrease the slump without affecting the yield strength.

the paste content in the concrete is in the range 25-40% of the concrete volume. the cement paste expose clear thixotropic behaviour.

even concrete with porous, lightweight aggregates may be pumped at usual pumping pressures (<150 bar).

the cement paste (the binder) is usually composed of at least three solid components in addition to palygorskite, e.g. Portland Cement, microsilica and an industrial or natural pozzolanic powder.

the palygorskite is characterised by an aspect ratio (length/diameter ratio)>35.

Several tests have demonstrated that concrete produced in accordance with this invention expose a stable (high) plastic viscosity tolerating even some variation in the water content and that the rheology of the concrete—particularly the internal and external segregation tendencies—is not effected by minor variations in the water content. Consequently, the concrete could be characterized as tolerant towards variations in the water content.

Three full-scale demonstrations have proven that properties like e.g. permeability, strength and adhesion to the reinforcement were very satisfying and that the concrete was stable during production and of a general high quality. The full-scale structures did not expose any of the deficiencies which were described in the section ‘background’ and the concrete filled the structure completely.

### EXAMPLES OF COMPOSITIONS

Example no. 1

| | |
|---|---|
| Cement, CEM 132.5, supplier EBCI, NL | 300 kg/m³ |
| Microsilica, Supplier Elkem, N | 5 kg/m³ |
| Palygorskite, trade name Attapulgite. supplier Tola, E | 16,5 kg/m³ |
| Metakaolin, English China Clay, ND 500, GB | 16.5 kg/m³ |
| Water (total free water) | 181 kg/m³ |
| Peramin FS, superplasticiser, supplier Perstorp, SE | 8,3 kg/m³ |
| Air entrainer, Perstorp, SE | 2,0 kg/m³ |
| Sand 0-4mm | 568 kg/m³ |
| River gravel 4-8 mm | 366 kg/m³ |
| River gravel 8-16 mm | 476 kg/m³ |
| River gravel 16-32 mm | 421 kg/m³ |
| In total | 2,360 kg/m³ |

Example no. 2

| | |
|---|---|
| Cement, CEM III. Supplier CEMIJ, NL | 314 kg/m³ |
| Palygorskite, trade name Attapulgite, supplier Tolsa, E | 16,5 kg/m³ |
| Water (total free water) | 181 kg/m³ |
| Melment L4004, superplasticiser, Nordisk Byggekemi, DK | 8,3 kg/m³ |
| Air entrainer, Amex SB, Nordisk Byggekemi, DK | 2,0 kp/m³ |
| Sand 0-4 mm | 562 kg/m³ |
| River gravel 4-8 mm | 362 kg/m³ |
| River gravel 8-16 mm | 476 kg/m³ |
| River gravel 16-32 mm | 417 kg/m³ |
| In total | 2,334 kg/m³ |

Example no. 3

| | |
|---|---|
| Cement, CEM I 42.5, supplier Aalborg Portland, DK | 260 kg/m³ |
| Microsilica, Supplier Elkem, N | 26 kg,/m³ |
| Palygorskite, trade name Attapulgite, supplier Tolsa, E | 14 kg/m³ |
| Metakaolin, English China Clay, ND 500, GB | 32 kg/m³ |
| Water (total free water) | 151 kg/m³ |
| Peramin FS, superplasticiser, supplier Perstorp, SE | 10 kg/m³ |
| Peramin V, water reducing agent. supplier Perstorp, SE | 1 kg/m³ |
| Peramin L, Air entrainer, supplier Perstorp, SE | 0,5 kg/m³ |
| Sand 0-2 mm | 725 kg/m³ |
| Crushed granite 5-8 mm | 180 kg/m³ |
| Crushed granite 8-16 mm | 400 kg/m³ |
| Crushed granite 16-32 mm | 530 kg/m³ |
| In total | 2,330 kg/m³ |

Example no. 4

| | |
|---|---|
| Cement, CEM I 42.5, supplier Aalborg Portland, DK | 350 kg/m³ |
| Palygorskite, trade name Attapulgite, supplier Tolsa, E | 13 kg/m³ |
| Metakaolin. English China Clay, ND 500, GB | 30 kg/m³ |
| Water (total free water) | 170 kg/m³ |
| Rheobuild 5000, superplasticiser, Master Builders, DK | 11 kg/m³ |
| Peramin L, Air entrainer, supplier Perstorp, SE | 0,5 kg/m³ |
| Sand 0-4 mm | 620 kg/m³ |
| Crushed granite 5-8 mm | 235 kg/m³ |
| Crushed granite 8-16 mm | 400 kg/m³ |
| Crushed granite 16-32 mm | 530 kg/m³ |
| In total | 2,360 kg/m³ |

Example no. 5

| | |
|---|---|
| Cement, CEM 1152.5, supplier Aalborg Portland, DK | 200 kg/m³ |
| Palygorskite, trade name Attapulgite, supplier Tolsa, E | 10 kg/m³ |
| GGBFS, Blame 420, CEMIJ, NL | 150 kg/m³ |
| Microsilica, Elkem, N | 10 kg/m³ |
| Water (total free water) | 150 kg/m³ |
| Glenium¹, Superplast, Master Builders, DK | 3 kg/m³ |
| Sand 0-2 mm | 600 kg/m³ |
| Crushed granite 4-8 mm | 240 kg/m³ |
| Crushed granite 8-16 mm | 400 kg/m³ |
| Crushed granite 16-25 mm | 600 kg/m³ |
| In total | 2,360 kg/m³ |

1. Self-levelling, self-compacting concrete produced on the basis of Portland Cement and/or other hydraulic binders such as pozzolans with addition of water and aggregate characterized by a content of palygorskite in combination with one or more types of superplasticising additives.

2. Self-levelling, self-compacting concrete in accordance with claim 1, characterized by a content of palygorskite in an amount of 2-12% of the binder.

3. Self-levelling, self-compacting concrete in accordance with claim 1 characterized by the content of superplasticising additive in dry of dissolved form, e.g. sulphonated melaminformaldehyde, sulphonated naphthalene or additives of type Glenium in an amount of 2-15 kg/m³ depending on effect of such additives (amounts given for saturated solutions) with a dosage to obtain a slump exceeding 150 mm before addition of palygorskite.

4. Self-levelling, self-compacting concrete in accordance with claim 1 characterized by a binder content of 300-450 kg binder per m³ and 0-10% microsilica.

5. Self-levelling, self-compacting concrete in accordance with claim 1 characterized by the use of porous aggregate.

6. The use of micro-stabilized concrete in accordance with claim 1 for concrete structures.

7. Procedure for production of self-levelling, self-compacting concrete based on Portland cement and/or other binders such as pozzolans and aggregate. The composition is characterized by the addition of one or more superplasticisers in combination with an addition of palygorskite.

8. Procedure for production of self-levelling, self-compacting concrete in accordance with claim 7 characterized by the addition of an amount of superplasticiser and addition of palygorskite and palygorskite in an amount of 2 -12% of the binder.

9. Application of self-levelling, self-compacting concrete in accordance with claim 7 for construction of concrete structures.

10. Application of self-levelling, self-compacting concrete or a self-levelling, self-compacting concrete produced in accordance with claim 1, and using a porous aggregate, placed in the structures by pumping.
